(19) United States
(12) Patent Application Publication
(10) Pub. No.: US 2006/0207376 A1
(43) Pub. Date: Sep. 21, 2006

(54) BICYCLE CONTROL APPARATUS

(75) Inventors: Christopher Shipman, Chicago, IL (US); Brian Jordan, Chicago, IL (US); Kevin Wesling, Lombard, IL (US); Kent Solberg, Woodstock, IL (US)

Correspondence Address: SRAM CORPORATION, 1333 N. KINGSBURY, 4TH FLOOR, CHICAGO, IL, 60622, US

(73) Assignee: SRAM CORPORATION, Chicago, IL (US)

(21) Appl. No.: 10/906,738

(22) Filed: Mar. 3, 2005

(51) Int. Cl. G05G 11/00

(52) U.S. Cl. 74/489

(57) ABSTRACT

A bicycle control apparatus mountable to a bicycle handlebar that includes a brake lever assembly and a shift lever assembly. The brake lever assembly includes a brake lever rotatable about a brake lever axis. The shift lever assembly includes a shift lever rotatable about a shift lever axis. The shift lever axis and the brake lever axis form an angle less than 90 degrees therebetween.

### BACKGROUND OF THE INVENTION

The present invention relates to bicycle control apparatuses, and more particularly, to a bicycle control apparatus including a brake lever rotatable about a brake lever axis and a shift lever rotatable about a shift lever axis, wherein the shift lever axis and the brake lever axis form an angle therebetween of less than 90 degrees.

A bicycle control apparatus that includes both a brake lever assembly and a shift lever assembly may be mounted to a handlebar of a road bike. Looking to FIG. 1, the road bike typically includes a drop-style handlebar 10 having an upper portion 12 extending horizontally across a bicycle frame (not shown), a curved portion 14 extending downward from the upper portion 12, and a lower portion 16 extending rearward toward the rider. This type of handlebar provides numerous hand grip positions for the rider, including positions at various heights. One available hand position is on the upper portion 12, another somewhere on the curved or lower portions 14, 16, commonly referred to as “riding in the drops.”

A conventional bicycle control apparatus typically includes a housing 18, a brake lever assembly 20 and a shift lever assembly 22. The housing 18 is mounted to the curved portion 14 of the handlebar 10 and is positioned to extend forward, away from the rider. The housing 18 typically includes a contoured surface 24 for the rider to rest his hands on while riding. Accordingly, the housing 18 is typically positioned such that contoured surface 24 forms an extension of the upper portion 12 of the handlebar 10.

Looking to FIG. 2, the housing 10 has a centerline H. The brake lever assembly 20 includes a brake lever 26 operably mounted to the housing 18 to pivot rearward, toward the rider, about a brake lever axis BL, to slow the bicycle. The brake lever axis BL is aligned perpendicular to centerline H. The shift lever assembly 22 includes a shift lever 28 that rotates about a shift lever axis SL. The shift lever axis SL is aligned parallel to the central axis H of the housing 18 and perpendicular to the brake lever axis BL. The brake lever 26 may be reached by the rider from several hand grip positions, including when the rider's hands are on the contoured surface 24 of the housing 18, or on the drops of the handlebar 10. The rider usually places his hands in the drops 14, 16 for more power and better aerodynamics to maximize speed. Naturally, it's important that the rider maintain a firm grip on the handlebar 10 for greater control and power.

Looking to FIG. 3, at rest, the rider's hand grips the lower portion 16 of the handlebar 10, with the rider's fingers wrapped around the handlebar 10. To shift gears, the rider must first extend one or two fingers toward shift lever 28 (FIG. 4), then push shift lever 28 laterally, or inward, toward the centerline of the bike. As the rider further displaces the shift lever 28 toward the bike centerline, the more he must reach to maintain contact with shift lever 28. So much so, that toward the end of the shift operation, the rider must at least partially release his grip on the handlebar and rotate his hand about the handlebar to move the shifter lever 28 enough to complete a shift. Releasing the grip, and stretching and twisting the hand is not only uncomfortable, but creates a dangerous riding condition where the rider may readily lose control of the bicycle, especially when riding on rough terrain. Accordingly, there is a need to provide an integrated brake and shift lever device that allows full actuation of the shift lever without changing hand positions on the handlebar.

### SUMMARY OF THE INVENTION

The present invention provides a bicycle control apparatus mountable to a bicycle handlebar. In one embodiment of the present invention, the bicycle control apparatus includes a housing mountable to the handlebar, a brake lever assembly and a shift lever assembly. The housing has a centerline. The brake lever assembly includes a brake lever operatively connected to the housing and rotatable about a brake lever axis. The shift lever assembly includes a shift lever operatively connected to the housing and rotatable about a shift lever axis, the shift lever axis forming an angle with the brake lever axis of less than 90 degrees. Such an angle permits the shift lever to deflect both inwardly, toward the centerline of the bike, and rearward, toward the rider, forming an arcuate path during actuation that more closely follows the natural arcuate path of the fingers as they pivot about the knuckles. The arcuate motion of the shift lever allows the rider to shift while maintaining a full grip on the handlebar. In a preferred embodiment of the invention, the shift axis forms an angle of 10 to 80 degrees with the brake axis. In yet further embodiments, the shift axis forms an angle of 50 to 70 degrees with the brake axis.

These and other features and advantages of the present invention will be more fully understood from the following description of one or more embodiments of the invention, taken together with the accompanying drawings.

### BRIEF DESCRIPTION OF THE DRAWINGS

In the drawings:

FIG. 1 is a perspective view of a prior art bicycle control apparatus;

FIG. 2 is a top view of the prior art bicycle control apparatus of FIG. 1;

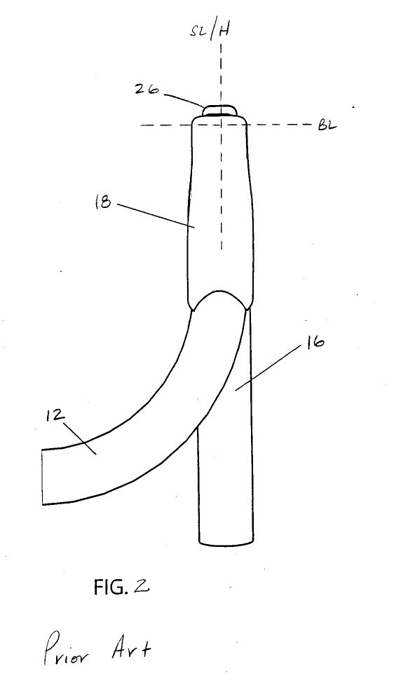

FIG. 3 is a top view of a rider's hand gripping a bicycle handlebar;

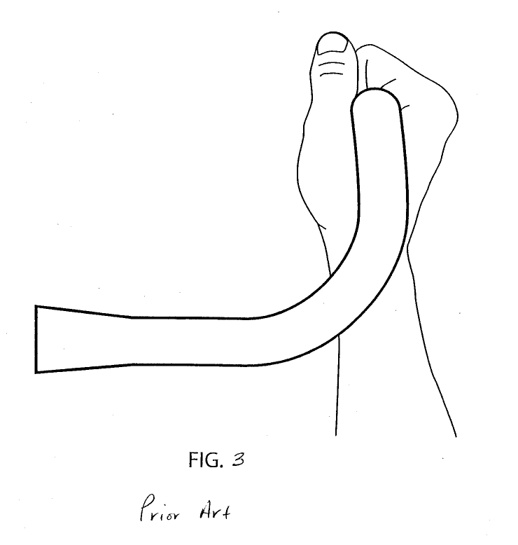

FIG. 4 is a top view of a rider's hand gripping a bicycle handlebar, while initiating a shift operation;

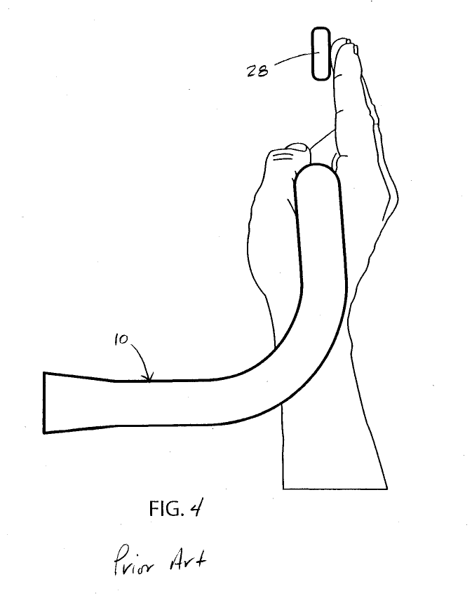

FIG. 5 is a top view of the prior art bicycle control apparatus of FIG. 1 showing a shift lever in a deflected position;

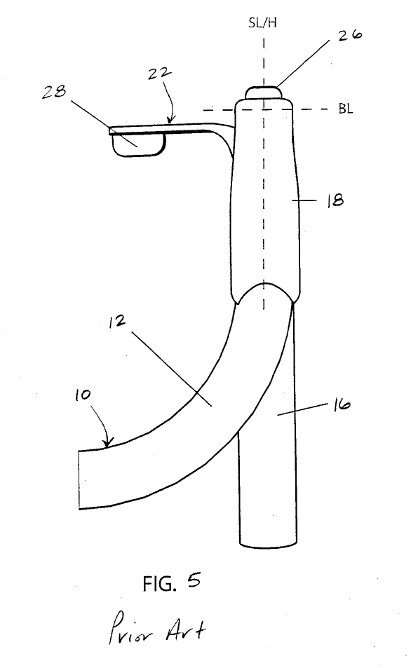

FIG. 6 is a top view of a rider's hand gripping the handlebar, showing in particular, the rider's hand movement through a shifting operation from shift lever position 28a to shift lever position 28b;

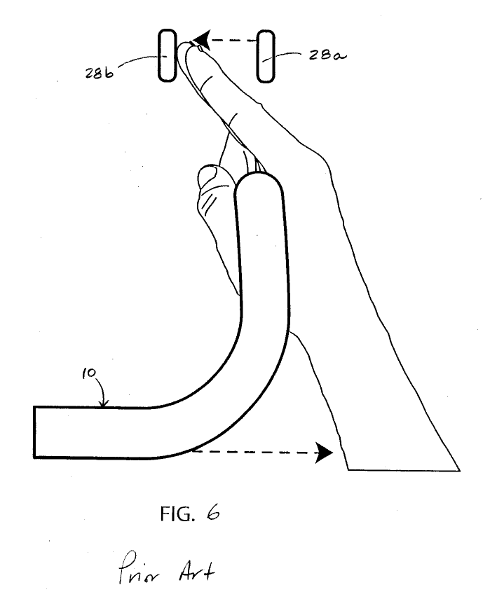

FIG. 7 is a top view of a bicycle control apparatus according to one embodiment of the present invention;

FIG. 8 is a partial cross-sectional view of the bicycle control apparatus of FIG. 7; and

FIG. 9 is a top view of a rider's hand gripping the handlebar, showing in particular, the rider's hand movement through a shifting operation from shift lever position 122a to shift lever position 122b.

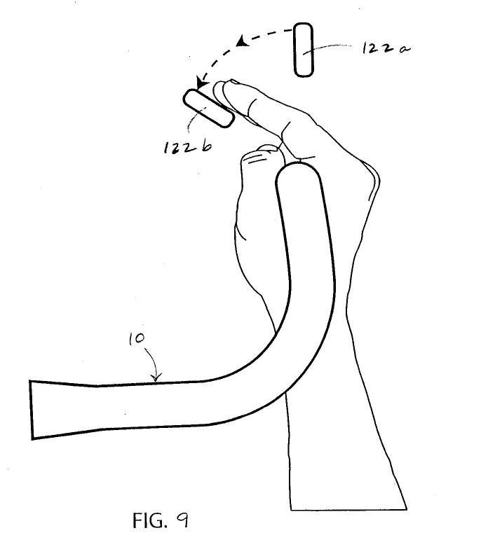

### DETAILED DESCRIPTION

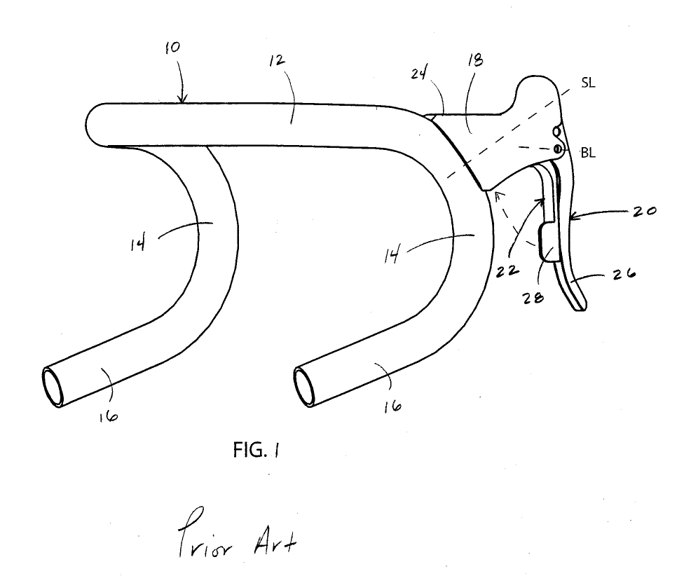

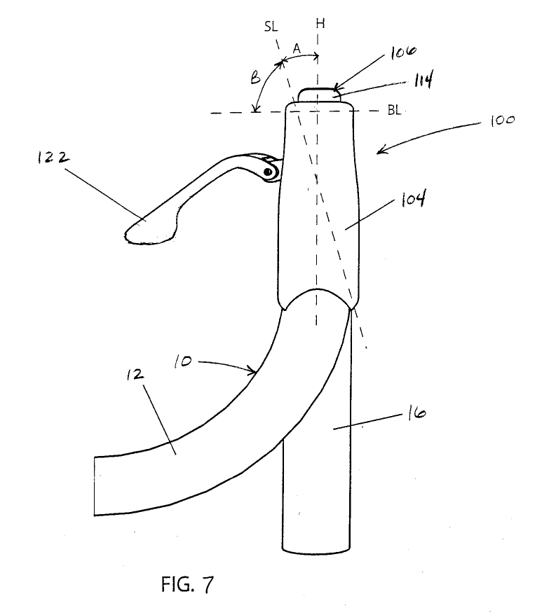

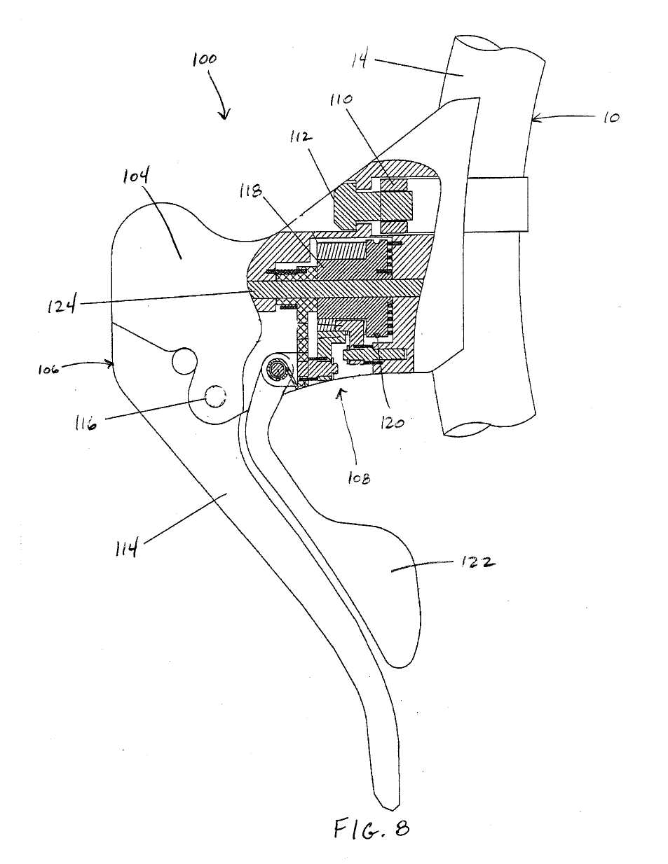

FIGS. 7 and 8 illustrate a bicycle control apparatus 100 mountable to a bicycle handlebar 10, according to one embodiment of the present invention. The bicycle control apparatus 100 generally includes a housing 104, a brake lever assembly 106, and a shift lever assembly 108. The bicycle handlebar 10 shown is of the drop-style type, typically found on a road bike; however, this invention is applicable to any style handlebar found on different types of bicycle. Looking to FIG. 1, the handlebar 10 includes an upper portion 12 extending across the bicycle frame (not shown), a curved portion 14 extending downward from the upper portion, and a lower portion 16 extending rearward toward the rider. The curved portion 14 and the lower portion 16 are commonly referred to as the “drops.” The housing 104 is typically mounted to the curved portion 14 of the handlebar 102 by a clamp 110 and a bolt 112, the housing having a centerline H.

The brake lever assembly 106 includes a brake lever 114 mounted rotatably to a pivot 116 extending through the housing 104, the pivot 116 forming a brake lever axis BL. The brake lever axis BL is typically perpendicular to the centerline H of the housing 104, but need not be so oriented.

The shift lever assembly 108 generally includes a cable spool 118 for pulling and releasing a control cable 120 connected to a gear change mechanism (not shown), and a shift lever 122 for rotating the cable spool 118 in cable-pull and cable-release directions. This invention is applicable to various shift lever assembly configurations and is not limited to the embodiment of FIG. 8. Typically, the shift lever 122 is rotatably mounted to a pivot 124 extending from the housing 104, pivot 124 forming a shift lever axis SL. Alternatively, the shift lever 122 may be rotatably mounted to the brake lever assembly 106. The brake lever axis BL need not intersect the shift lever axis SL. Additionally, the shift lever axis SL need not intersect the housing centerline H. According to the invention, the shift lever axis SL and the brake lever axis BL form an angle B therebetween of less then 90 degrees. Alternatively, the shift lever axis SL and the housing centerline H form an angle A therebetween of less then 90 degrees. So configured, the shift lever 122 is permitted to deflect both rearward, toward the rider, and inwardly, toward the bicycle centerline, forming an arcuate path of deflection that follows the natural arcuate path of the rider's fingers as they pivot about the knuckles of the hand during lever actuation. The arcuate motion of the shift lever 122 allows the rider to actuate the shift lever 122 through one or more gear positions without removing or loosening his grip on the handlebar 10, permitting shifts with greater power, comfort, and control. In other embodiments, the shift lever axis SL and the brake lever axis BL may be configured to form an angle B therebetween in the range of 10 to 80 degrees, and optimally in the range of 50 to 70 degrees. In yet other embodiments, the shift lever axis SL and the housing centerline H may be configured to form an angle A therebetween in the range of 10 to 50 degrees, and optimally in the range of 20 to 40 degrees.

While this invention has been described by reference to one or more preferred embodiments, it should be understood that numerous changes could be made without departing from the spirit and scope of the inventive concepts described. Accordingly, it is intended that the invention not be limited to the disclosed embodiments, but that it be afforded the full scope of protection permitted by the language of the following claims.

1. A bicycle control apparatus mountable to a bicycle handlebar comprising:
a housing mountable to the bicycle handlebar;
a brake lever assembly having a brake lever operatively connected to the housing and rotatable about a brake lever axis; and
a shift lever assembly having a shift lever operatively connected to one of the housing and the brake lever assembly and rotatable about a shift lever axis, the brake lever axis and the shift lever axis forming an angle therebetween of less than 90 degrees.

2. The bicycle control apparatus of claim 1, wherein the brake lever axis and the shift lever axis form an angle between in the range of 10 to 80 degrees.

3. The bicycle control apparatus of claim 1, wherein the brake lever axis and the shift lever axis form an angle between in the range of 50 to 70 degrees.

4. A bicycle control apparatus mountable to a bicycle handlebar comprising:
a housing mountable to the bicycle handlebar, the housing having a centerline;
a brake lever assembly having a brake lever operatively connected to the housing and rotatable about a brake lever axis; and
a shift lever assembly having a shift lever operatively connected to one of the housing and the brake lever assembly and rotatable about a shift lever axis, the shift lever axis and the centerline forming an angle therebetween of less than 90 degrees.

5. The bicycle control apparatus of claim 4, wherein the housing centerline and the shift lever axis form an angle therebetween in the range of 10 to 50 degrees.

6. The bicycle control apparatus of claim 4, wherein the housing centerline and the shift lever axis form an angle therebetween in the range of 20 to 40 degrees.

7. A bicycle control apparatus mountable to a bicycle handlebar comprising:
a housing mountable to the bicycle handlebar;
a brake lever assembly having a brake lever operatively connected to the housing, the brake lever rotatable about a brake lever axis defining a brake lever plane of motion perpendicular to the brake lever axis; and
a shift lever assembly having a shift lever operatively connected to one of the housing and brake lever assembly, the shift lever rotatable about a shift lever axis defining a shift lever plane of motion perpendicular to the shift lever axis, the brake lever plane of motion and the shift lever plane of motion forming an angle therebetween of less than 90 degrees.

8. The bicycle control apparatus of claim 1, wherein the brake lever plane of motion and the shift lever plane of motion form an angle therebetween in the range of 10 to 80 degrees.

9. The bicycle control apparatus of claim 1, wherein the brake lever plane of motion and the shift lever plane of motion form an angle therebetween in the range of 50 to 70 degrees.
